(19) United States
(12) Patent Application Publication
(10) Pub. No.: US 2024/0166976 A1
(43) Pub. Date: May 23, 2024

(54) ODOR REMOVAL, STAIN REMOVAL, AND SURFACE CLEANING COMPOSITION

(71) Applicant: The Shat Ink LLC, Middletown, DE (US)

(72) Inventor: Elias Hasrouni, Parma, OH (US)

(21) Appl. No.: 17/990,679

(22) Filed: Nov. 19, 2022

(51) Int. Cl. C11D 7/40; C11D 1/62; C11D 3/10; C11D 3/12; C11D 3/20; C11D 11/00

(52) U.S. Cl. CPC C11D 7/40; C11D 1/62; C11D 3/10; C11D 3/1213; C11D 3/2003; C11D 11/0088

(57) ABSTRACT

A composition for odor removal, stain removal, and surface cleaning containing Lavender Fabuloso®, Gain® Ultra Clean, white vinegar, bleach, baking soda, and hydrogen peroxide. The composition may also contain ethyl alcohol 70% and one or more essential oils. The composition is contained, preferably in a sprayer. The composition is easily and rapidly sprayed from the sprayer onto walls, floors, ceilings, and counter tops to produce a sustained elimination of odors. The composition readily removes stains, dirt, and grease from surfaces. The composition also produces sustained antimicrobial effects.

### FIELD OF THE INVENTION

This invention relates to surface cleaners and, more particularly, to a surface cleaner that removes odors, stains, grease, and mold, and disinfects, with a single formulation.

### BACKGROUND OF THE INVENTION

Many different cleaning compositions have been developed for a variety of purposes. Cleaners may include action to remove grease and/or particulate soil, to deodorize, to disinfect, to remove stains, to remove mildew, to bleach, and to preserve color of the material being cleaned. However, a surface cleaner that adequately removes odors, stains, grease, and mold, and disinfects, with a single formulation, heretofore has not been available.

### SUMMARY OF THE INVENTION

This invention is a composition for odor removal, stain removal, and surface cleaning, containing Lavender Fabuloso®, Gain® Ultra Clean, white vinegar, bleach, baking soda, and hydrogen peroxide. The composition may further contain ethyl alcohol 70% and one or more essential oils. The composition of Lavender Fabuloso®, Gain® Ultra Clean, white vinegar, bleach, baking soda, and hydrogen peroxide are, preferably, contained in a sprayer.

An advantage of this invention is a composition that is easy to make and relatively inexpensive.

Another advantage is a composition that may be applied to walls, floors, ceilings, and counter tops quickly using a sprayer.

Another advantage is a composition that rapidly and effectively removes odors and stains from surfaces, including rugs and upholstery.

Another advantage is a composition that has antimicrobial effects.

### DETAILED DESCRIPTION OF THE INVENTION

While the following description details certain embodiments of the present disclosure, it is to be understood that the disclosure is not limited in its application to the details of compositions and combinations of the substances described herein since the disclosure is capable of other embodiments and of being practiced in various ways.

The surface cleaning composition of this invention comprises a mixture of the following ingredients in the following amounts: commercially available Lavender Fabuloso® (2-3 cups), white vinegar (4-6 cups), bleach (4-5 cups), backing soda (¼ teaspoon), commercially available Gain® Ultra Clean dishwashing soap (½-¾ cup), and hydrogen peroxide 3% (16-20 cups). The total liquid volume of the surface cleaning composition in this example ranges from 26.5 to 34.7 cups (8 liquid ounces per cup). To these liquid volumes are added ¼ teaspoon of sodium bicarbonate and 3 to 7 ounces of an essential oil.

Lavender Fabuloso® contains, water, sodium dodecylbenzenesulfonate, fragrance, C9-11 pareth-8, sodium C12-15 pareth-8, pareth sulfate or laureth sulfate, glutaral, citric acid, and colorants.

Wine vinegar contains 4-7% acetic acid and 93-96% water. Baking soda is sodium bicarbonate.

Bleach contains sodium hypochlorite, sodium hydroxide, sodium chloride, sodium carbonate, sodium polyacrylate, chlorine, calcium hypochlorite, sodium perborate sodium percarbonate.

Gain® Ultra Clean contains denatured alcohol, C10-16 alkyldimethylamine oxide, dipropylene glycol butyl ether, ethanolamine, fragrances, hexyl ethoxylate, phenoxyethanol, PPG-26, sodium citrate, sodium laureth sulfate, tetrasodium glutamate diacetate, water.

Essential oils include linalool, linalyl acetate, terpinen-4-ol, lavandulyl acetate, lavandulol, eucalyptol (1,8-cineole), and camphor [1,5,11-13,19-21].

In an alternant embodiment the following is added to the above formulation to increase anti-odor efficacy: 70% ethyl alcohol (1 cup).

A preferred process for making the composition is as follows. A first part is made by combining the Lavendar Fabulosa and the Gain Ultra Clean. A second part is made by combining the white vinegar and sodium bicarbonate. A third part is made by combining the bleach and the hydrogen peroxide. Essential oil can be included in the third part if desired. The three parts are then combined to form the composition.

Lavendar Fabuloso® is a surface cleaner for floors, bathrooms, and kitchens. Gain® Ultra Clean is a dishwashing liquid. Applicant discovered that the two products are compatible for mixing as recited in the formulation above. Applicant further discovered that the other ingredients, white vinegar, bleach, baking soda, and hydrogen peroxide, added to the mixture of Lavendar Fabuloso® and Gain® Ultra Clean provided surprisingly improved cleaning, odor removal, stain removal, and anti-microbial properties of the mixture. The complete formulation was also stable, with no separation of components, no toxic or unpleasant fumes, and no skin or lung irritation.

Surprisingly, the formulation could be applied with an inexpensive sprayer, allowing floors, walls, and ceilings, counters, and fans to be sprayed easily, thereby rapidly deodorizing and sanitizing an entire room within a few minutes. The sprayer can be any kind of sprayer, including a hand pump sprayer or an electric powered pump sprayer. The formulation can be applied to surfaces, including rugs, using towels, sponges, and the like to rapidly remove dirt, grease, and stains.

As an example, apartment complexes continually need to clean and prepare each apartment for each new renter. A used apartment typically has unacceptable odors related to cooking, animal odors, cigarette smoke, urine, and feces. Odorizing machines that apply ozone to kill odor causing bacteria require a technician to operate the machine. The process is time consuming and expensive and has relatively temporary effect. The composition of this disclosure is inexpensive, safe, can be applied quickly, and can be repeated as desired.

The foregoing description illustrates and describes the disclosure. Additionally, the disclosure shows and describes only the preferred embodiments but as mentioned above, it is to be understood that the preferred embodiments are capable of being formed in various other combinations, modifications, and environments and are capable of changes or modifications within the scope of the invention concepts as expressed herein, commensurate with the above teachings and/or the skill or knowledge of the relevant art. The embodiments described herein above are further intended to explain the best modes known by applicant and to enable others skilled in the art to utilize the disclosure in such, or other, embodiments and with the various modifications required by the particular applications or uses thereof. Accordingly, the description is not intended to limit the invention to the form disclosed herein. Also, it is intended that the appended claims be construed to include alternative embodiments.

The invention claimed is:

1. A composition for odor removal, stain removal, and surface cleaning, comprising: Lavender Fabuloso®, Gain® Ultra Clean, white vinegar, bleach, baking soda, and hydrogen peroxide.

2. The composition of claim 1, further comprising ethyl alcohol 70%.

3. The composition of claim 1, further comprising one or more essential oils.

4. The composition of claim 1, wherein the amounts of ingredients in the composition comprise: Lavender Fabulosa® 2-3 cups; Gain® Ultra Clean ½-¾ cups, white vinegar 4-6 cups, bleach (4-5 cups), sodium bicarbonate (¼ teaspoon), and hydrogen peroxide 3% 16-20 cups.

5. The composition of claim 4, further comprising ethyl alcohol 70% 1 cup and ammonia 1 teaspoon.

6. The composition of claim 3 wherein the amount of essential oil is 3-7 ounces.

7. The composition of claim 1 wherein Lavender Fabuloso®, Gain® Ultra Clean, white vinegar, bleach, baking soda, and hydrogen peroxide are contained in a sprayer.

8. A composition for odor removal, stain removal, and surface cleaning, comprising: Lavender Fabuloso®, Gain® Ultra Clean, white vinegar, bleach, baking soda, and hydrogen peroxide, wherein the amounts of ingredients in the composition comprise: Lavender Fabulosa® 2-3 cups; Gain® Ultra Clean ½-¾ cups, white vinegar 4-6 cups, bleach (4-5 cups), sodium bicarbonate (¼ teaspoon), and hydrogen peroxide 3% 16-20 cups.

9. The composition of claim 8, further comprising ethyl alcohol 70%.

10. The composition of claim 8, further comprising one or more essential oils.

11. The composition of claim 10 wherein the amount of essential oil is 3-7 ounces.

12. The composition of claim 8 wherein Lavender Fabuloso®, Gain® Ultra Clean, white vinegar, bleach, baking soda, and hydrogen peroxide are contained in a sprayer.

13. A composition for odor removal, stain removal, and surface cleaning, comprising: Lavender Fabuloso®, Gain® Ultra Clean, white vinegar, bleach, baking soda, and hydrogen peroxide, wherein the amounts of ingredients in the composition comprise: Lavender Fabulosa® 2-3 cups; Gain® Ultra Clean ½-¾ cups, white vinegar 4-6 cups, bleach (4-5 cups), sodium bicarbonate (¼ teaspoon), and hydrogen peroxide 3% 16-20 cups, wherein the ingredients are contained in a sprayer.

14. The composition of claim 14, further comprising alcohol 70% 1 cup wherein the amount of essential oil is 3-7 ounces.
